(19) United States
(12) Patent Application Publication
(10) Pub. No.: US 2008/0223772 A1
(43) Pub. Date: Sep. 18, 2008

(54) Purification Device

(76) Inventor: Jon Grant, Surrey (GB)

Correspondence Address: BLANK ROME LLP, 600 NEW HAMPSHIRE AVENUE, N.W., WASHINGTON, DC, 20037, US

(21) Appl. No.: 11/597,433

(22) PCT Filed: May 24, 2005
(86) PCT No.: PCT/GB2005/002029

§ 371 Date: Nov. 9, 2007

(30) Foreign Application Priority Data
May 24, 2004 (GB) 041530.9

(51) Int. Cl. B01D 37/02; C02F 1/76

(52) U.S. Cl. 210/193

(57) ABSTRACT

A fluid purification device comprises a tubular porous plastics filter member coated with a chemically treated resin whose side walls define an inner channel leading at one end to an outlet. The arrangement of the device is such that, in use, fluid is purified by passing through the resin coated side walls of the filter member into the inner channel.

The present invention relates to a purification device and in particular to a purification device that uses a combination of mechanical and chemical purification means.

It is often very important to have means to purify water or other fluid so that it is safe to consume, particularly when the only fluid available is dirty and highly contaminated with harmful compounds.

The present invention sets out to provide an improved purification device.

In one aspect, the invention provides a fluid purification device comprising a tubular porous plastics filter member coated with a chemically treated resin whose side walls define an inner channel leading at one end to an outlet, the arrangement being such that, in use, fluid is purified by passing through the resin coated side walls of the filter member into the inner channel.

Preferably the resin is chemically treated with iodine. Preferably still the resin comprises a fabricated nylon resin containing penta-iodide.

Preferably the end of the channel opposed to the outlet is closed by a base member. Preferably the base member is removable.

Preferably still, the base member has a central aperture extending therethrough.

Preferably, the base member includes a cap having a plurality of circumferential apertures.

Preferably, the channel of the outlet end of the filter member is open to receive a tubular stem one end of which forms the outlet.

In a second aspect there is provided a fluid purification device comprising a tubular porous plastics filter member coated with a chemically treated resin whose side walls define an inner channel leading at one end to an outlet, the other end of the channel being closed by an apertured base member.

One embodiment of the present invention will now be described by way of which:-

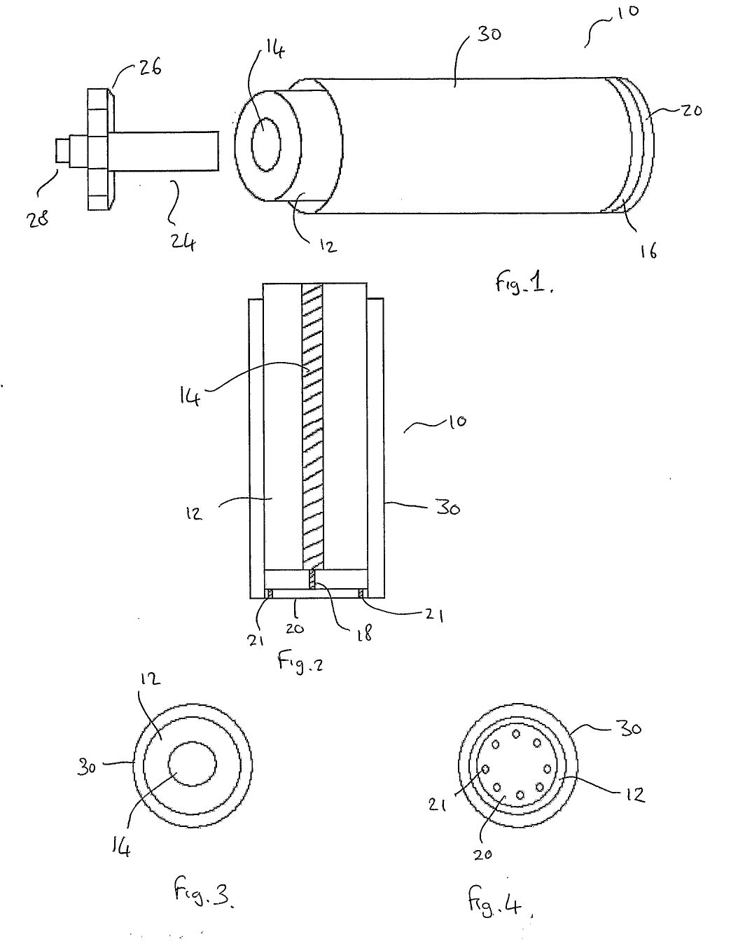

FIG. 1 is a side perspective view of a water purifier constructed in accordance with the present invention;

FIG. 2 is a side section view of the water purifier of FIG. 1; and

FIGS. 3 and 4 are end section view of the water purifier of FIGS. 1 and 2.

Referring first to FIGS. 1 and 2, a fluid purification device 10 constructed in accordance with the present invention comprises a cylindrical filter member 12 made of porous plastic material. The mean pore sizes of the filter member 12 are typically approximately 2 μm, although it will be appreciated that the porosity and mean pore sizes of the filter member will at least in part be determined by the application of the purification device and the types of water or other liquids to be purified. Although the filter member 12 is shown to be annular in the drawings, it can be of any suitable shape. For example, the filter may take the shape of a flattened cylinder having the appearance of a hip-flask.

The filter member 12 is tubular in construction and has an inner longitudinally extending channel 14. Although the Figures show the inner channel 14 to be spherical in cross-section, it is clearly envisaged that channel 14 could be of any suitable cross-section.

As is best seen in FIG. 4, one end of the filter member 12 is closed by a removable base member 16. The base member 16 has incorporated therein an “umbrella valve”. The base member 16 has a central aperture 18 extending therethrough. The base member 16 may have further apertures in the vicinity of the central aperture 18. Finally the distal end of the base member 16 has a cap 20 which has a plurality of small circumferential apertures 21. When in use, and as will be described later, the apertures 18, 21 allow for air to flow down through channel and out through the base member 20 while preventing fluid to flow back through the base member into the channel 14.

The other end 22 of the channel 14 of the filter member 12 is open so to allow a tubular stem 24 to be received therein. The stem 24 extends through a lid portion 26 to an outlet 28.

In use, fluid contained within the inner channel 14 of the filter member 12 can flow from the channel 14 and through the outlet 28 via the stem 24. The outlet 28 may include a mechanical valve (not shown) to open and close the outlet 28 when desired. Such valves are common in the art.

The lid portion 26 includes an internal thread (not shown) for engagement with a corresponding thread formed on the rim of an outer casing of, for example, a water bottle, in which the filter member 12 can be encased.

The outside surface of the filter member 12 has a chemically treated fabricated nylon resin 30 adhered, or otherwise attached, thereto. The resin 30 is chemically treated by, for example, bonding nylon beads (of, for example, 1 mm diameter) with Penta-Iodide (I₅). Fluid, for example water, which passes through the resin 30 is therefore treated and purified by way of the iodine leaking into the water.

Although the description refers to the resin 30 being chemically treated with iodine, it is clearly envisaged that any similar chemical, for example chlorine, may be used, providing the chemical has the ability to break down bacteria and enzymes within the fluid to at least begin to purify the fluid.

Water that has passed through the chemically treated resin 30 then passes through the side walls of the filter member 12 due to the porosity of the plastic material of the filter member 12. The pores within the walls of the filter member act as size-filter. Any harmful compounds, such as for example, crypto-sporidium, still in the water after it has passed through the resin 30 are therefore removed from the water as it passes through the walls of the filter member and into the inner channel 14. Consequently, the water that flows into the channel 12 is purified to the extent that it is safe to be drunk by a human.

As already mentioned, the water can be accessed from the inner channel 14 by simply sucking on the outlet 28 of the stem 24. Once sufficient water has been drunk, the air pressure within the inner channel 14 of the filter 12 is equalised through via flow of air through umbrella valve in the base 16 of the filter member 12.

The above described embodiment has been given by way of example only, and the skilled reader will naturally appreciate that many variations could be made thereto without departing from the scope of the present invention.

1. A fluid purification device comprising a tubular porous plastics filter member coated with a chemically treated resin whose side walls define an inner channel leading at one end to an outlet, the other end of the channel being closed by an apertured base member, the arrangement being such that, in use, fluid is purified by passing through the resin coated side walls of the filter member into the inner channel.

2. A device as claimed in claim 1 wherein the resin is chemically treated with iodine.

3. A device as claimed in claim 1 wherein the resin comprises a fabricated nylon resin containing penta-iodide.

4. A device as claimed in claim 1 wherein the end of the channel opposed to the outlet is closed by a base member.

5. A device as claimed in claim 4 wherein the base member is removable.

6. A device as claimed in claim 4 wherein the base member has a central aperture extending therethrough.

7. A device as claimed in claim 4 wherein the base member includes a cap having a plurality of circumferential apertures.

8. A device as claimed in claim 1 wherein the channel of the outlet end of the filter member is open to receive a tubular stem one end of which forms the outlet.

9. (canceled)

10. (canceled)
